(19) United States
(12) Patent Application Publication
(10) Pub. No.: US 2011/0293971 A1
(43) Pub. Date: Dec. 1, 2011

(54) Battery Module

(76) Inventors: Pei-Jan Ho, Kaohsiung City (TW); Yuan-Sheng Chen, Hsinchu County (TW); Ren-Ting Chuang, Taoyuan County (TW); Yu-Wen Wu, Miaoli County (TW); Nan-Chun Wu, Tainan City (TW); Chao-Feng Lee, Hsinchu County (TW); Ching-Ping Yao, Taoyuan County (TW)

(21) Appl. No.: 13/208,362

(22) Filed: Aug. 12, 2011

(30) Foreign Application Priority Data
Jul. 8, 2011 (TW) 100124294
Jul. 13, 2011 (TW) 100124776

(51) Int. Cl. H01M 2/20; H01M 2/10; H01M 2/24; B23K 31/02; H01M 10/04; B29C 45/14; B23K 20/10; B23K 20/12; H01M 2/02; B23K 26/20

(52) U.S. Cl. 429/7; 429/99; 429/151; 429/159; 219/121.64; 29/623.1; 264/261; 228/110.1; 228/112.1; 228/179.1

(57) ABSTRACT

The present invention discloses a battery module including a casing capable of supporting a plurality of battery cells and having a circuit board holding structure, a circuit board held by the circuit board holding structure, a plurality of conducting buses disposed on the casing for electrically connecting the plurality of battery cells and the circuit board, and a plurality of battery cell sets, each of which including a battery holder and at least two battery cells, where any two of the plurality of battery cell sets are independent in structure and thereby can be affixed to the casing or detached from the casing respectively.

### BACKGROUND OF THE INVENTION

1. Field of the Invention

The present invention relates to a battery module, especially to a battery module suitable for production.

2. Description of the Prior Art

A conventional battery module usually utilizes wires for connecting the circuits inside it. For example, it utilizes a wire for connecting a circuit board and the positive electrode of a first battery set; a wire for connecting the circuit board and a nickel strip disposed between the first battery set and a second battery set; a wire for connecting the circuit board and another nickel strip disposed between the second battery set and a third battery set; and a wire for connecting the circuit board and the negative electrode of the third battery set.

According to the prior art, the connection between the nickel strip, the circuit board and the wires is carried out by using solder which is eco-unfriendly. Furthermore, the soldering process may be seriously affected by human factors which may cause the problems such as cold welding, missing weld, solder beading, and solder dross. Therefore, the applicant discloses a battery module in a previously filed U.S. patent application (U.S. patent application Ser. No. 13/079,535) to tackle the above-mentioned problems. Afterward, the applicant further improves the design of the battery module and consequently files the current application.

### SUMMARY OF THE INVENTION

The present invention discloses a battery module comprising: a casing which is capable of holding a plurality of battery cells and has a circuit board holding structure; a circuit board held by the circuit board holding structure; a plurality of conducting buses disposed on the casing for electrically connecting the plurality of battery cells and the circuit board; and a plurality of battery cell sets, each of which including at least two battery cells and being independent from any of the other battery cell sets in structure, so that the battery cell sets can be affixed to the casing and detached from the casing respectively.

An embodiment of the aforementioned battery cell set comprises: a battery holder including a fastening structure capable of being affixed to the casing; a first battery cell disposed at a first side of the battery holder; a second battery cell disposed at a second side of the battery holder, so that the first battery cell and the second battery cell embrace the battery holder from both of the first and second sides; a first conducting strip for electrically connecting positive electrodes of the first and second battery cells to a first conducting bus of the plurality of conducting buses; and a second conducting strip for electrically connecting negative electrodes of the first and second battery cells to a second conducting bus of the plurality of conducting buses, wherein any two of the adjacent battery cell sets share the same first or second conducting bus, so as to achieve the effect of series or parallel connection. Moreover, the first and second conducting strips are also used for binding the battery holder and the first and second battery cells together.

In an embodiment of the present invention, the aforementioned battery holder is a moveable battery holder. The moveable battery holder, accompanied with the first and second battery cells and the first and second conducting strips, is capable of being affixed to the casing and detached from the casing in a reversible way. In another embodiment of the present invention, the aforementioned battery holder is an immobile battery holder which can be affixed to the casing firmly.

The present invention also discloses a bus layout structure of a battery module, the bus layout structure comprising: a casing for holding a plurality of battery cells; and a plurality of conducting buses being integrated with the casing, wherein one end of each of the conducting buses is for electrically connecting to a circuit board; a part of the plurality of conducting buses is exposed for connecting with the plurality of battery cells; and another part of the plurality of conducting buses is implanted inside the casing without exposing itself, so as to avoid direct contact with the plurality of battery cells, which may cause safety issues.

In an embodiment of the present invention, the aforementioned plurality of conducting buses is implanted inside the casing through the following steps: providing a plurality of conducting buses and/or at least a wire (e.g. a wire for connecting a circuit board and a thermistor); providing a mold; disposing the plurality of conducting buses and/or the wire inside the mold; injecting a melted non-conductive material into the mold; and cooling the melted non-conducting material (e.g. plastic material) and performing a mold-release process, so as to form a casing, wherein the casing is capable of holding a plurality of battery cells and integrated with the plurality of conducting buses and/or the wire; a part of the plurality of conducting buses and/or the wire is exposed for connecting to the plurality of the battery cells; and another part of the plurality of conducting buses and/or the wire is implanted inside the casing to avoid direct contact with the plurality of the battery cells.

In addition to the aforementioned bus layout structure, the present invention provides another bus layout structure of a battery module, which comprises: a casing capable of holding a plurality of battery cells; a plurality of conducting buses disposed on the casing, wherein a part of the plurality of conducting buses is exposed and another part of the plurality of conducting buses is unexposed; and a non-conductive film (e.g. a plastic film such as a mylar film) covering the unexposed part of the plurality of conducting buses and being fixed to the casing, so as to immobilize the plurality of conducting buses, wherein the exposed part of the plurality of conducting buses connects to the plurality of battery cells.

For realizing the above-mentioned bus layout structure with the non-conductive film, the present invention provides a bus layout method comprising the steps of providing a casing capable of holding a plurality of battery cells; disposing a plurality of conducting buses and/or at least a wire (e.g. a wire for connecting a circuit board and a thermistor) on the casing; providing a non-conductive film (e.g. a plastic film such as a mylar film) for covering a part of the plurality of conducting buses and/or the wire and a part of the casing; positioning a mask on the non-conductive film; and providing energy without physical contact for the places where the non-conductive film covers the part of the casing, so as to combine the non-conductive film with the casing in an irreversible way and thereby immobilize the plurality of conducting buses and/or the wire covered by the non-conductive film, wherein a part of the plurality of buses which is not covered by the non-conductive film is for connecting with the plurality of the battery cells. Furthermore, the step of providing energy without physical contact is carried out by utilizing a non-contact welding technique such as the laser welding technique.

In addition to the aforementioned bus layout structures, the present invention further provides another bus layout structure of a battery module, which comprises: a casing capable of holding a plurality of battery cells; a plurality of conducting buses, each of which having at least one opening; and a plurality of fastenings, each of which being a part of the casing or a detached fastening, wherein each of the plurality of fastenings is inserted into one of the openings, has one end staying under the opening and being fixed to the casing, and has another end staying above the opening and being fixed to the conducting bus of the opening. Therefore, since one end of the fastening is fixed to the casing while another end of the fastening is fixed to its corresponding conducting bus, the casing and the conducting bus is thereby bound together by the fastening.

In order to realize the above-mentioned bus layout structure with the fastenings, the present invention provides a bus layout method comprising: providing a casing capable of holding a plurality of battery cells; providing a plurality of conducting buses, each of which having at least one opening; providing a plurality of fastenings, each of which being a part of the casing or a detached fastening; putting the openings of the plurality of conducting buses on the fastenings respectively, wherein each of the plurality of fastenings is inserted into one of the openings, has one end fixed to the casing, and has another end fixed to the conducting bus of the opening; and providing energy with physical contact for the plurality of fastenings, so as to partially melt the plurality of fastenings to thereby combine the plurality of conducting buses with the casing by the fastenings, wherein the step of providing energy with physical contact utilizes one of the heat fusion welding technique, ultrasonic welding technique and vibration welding technique.

The present invention also discloses a connection structure between battery cells and conducting buses of a battery module. The connection structure comprises: a casing capable of holding a plurality of battery cells including a first battery cell; a plurality of conducting strips having a first conducting strip, each of the conducting strips having one end connecting to at least one of the battery cells; a plurality of conducting buses disposed on the casing and connected to the plurality of battery cells through the plurality of conducting strips, wherein the plurality of conducting buses includes a first conducting bus, the first battery cell connects to the first conducting bus through the first conducting strip, and the first conducting bus has a protrudent part (e.g. a protrudent part in an upside-down U-shape) for realizing the contact between the first conducting bus and the first conducting strip; and a flexible pad (e.g. a soft pad made of rubber) placed under the protrudent part on the casing for providing an upward force to make the first conducting bus closely connect to the first conducting strip.

Another connection structure between battery cells and conducting buses of a battery module of the present invention comprises: a casing capable of holding a plurality of battery cells including a first battery cell; a plurality of conducting strips having a first conducting strip, each of the conducting strips having one end connecting to at least one of the battery cells; a plurality of conducting buses disposed on the casing and connected to the plurality of battery cells through the plurality of conducting strips, wherein the plurality of conducting buses includes a first conducting bus, the first battery cell connects to the first conducting bus through the first conducting strip, and the first conducting bus has a protrudent part (e.g. a protrudent part in an upside-down U-shape) for realizing the contact between the first conducting bus and the first conducting strip; and a conductive bump (e.g. a silver bump) placed on the protrudent part for assisting the connection between the first conducting bus and the first conducting strip. In a preferred embodiment, the conductivity of the conductive bump is higher than the conductivity of the first conducting bus for better conduction.

The present invention further discloses a connection method for connecting battery cells and conducting buses of a battery module. The connection method comprises: forming a casing which is capable of supporting a plurality of battery cells and has a plurality of openings; providing a plurality of conducting strips, each of which connecting to at least one of the battery cells; disposing a plurality of conducting buses on the casing, the plurality of conducting buses connecting to the plurality of battery cells through the plurality of conducting strips, each of the conducting buses defining a contact position where it covers one of the openings of the casing; making each of the conducting strips cover one of the contact positions, so that the conducting strips overlap the contact positions which further overlap the openings of the casing; and providing energy for the contact positions through the openings of the casing, so as to combine the conducting strips with the conducting buses and thereby realize the electric connection between the conducting buses and the battery cells through the conducting strips. Additionally, the step of providing energy for the contact positions may utilize any of the laser welding technique, spot welding technique, heat fusion welding technique and ultrasonic welding technique.

The present invention also provides a connection structure between a circuit board and conducting buses of a battery module. The connection structure comprises: a circuit board including a plurality of contact positions and a plurality of conductors, each of the conductors having a vertical part for connecting one of the plurality of contact positions and having a cross-section in L-shape; a casing being capable of supporting a plurality of battery cells and having a circuit board holding structure which includes at least a holding space for accommodating the circuit board, a plurality of supports for sustaining the circuit board from both sides of the circuit board, and at least a connection gate; and a plurality of conducting buses disposed on the casing, wherein each of the plurality of conductors has a horizontal part paralleling the casing, and the horizontal parts of the plurality of conductors connect with the plurality of conducting buses, so that the connection between the circuit board and the conducting buses can be carried out by the conductors via the connection gate.

Another connection structure between a circuit board and conducting buses of a battery module of the present invention comprises: a circuit board; a casing capable of supporting a plurality of battery cells; and a plurality of conducting buses disposed on the casing, wherein each of the conducting buses has one end connecting to one of the battery cells and another end as a board connection part, each of the board connection parts has a cross-section in U-shape, upside-down Ω-shape, or triangle-bell shape and is capable of holding the circuit board, and the circuit board can thereby electrically connect to the plurality of battery cells through the board connection parts of the conducting buses.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a battery module embodiment of the present invention.

FIG. 2a illustrates a first embodiment of the battery cell set of FIG. 1.

FIG. 2b illustrates how the first and second subsidiary fastening structures of FIG. 2a connect with the casing.

FIG. 2c illustrates a second embodiment of the battery cell set of FIG. 1.

FIG. 2d illustrates how the fastening structure of the immobile battery holder of FIG. 2c connects with the casing.

FIG. 3a illustrates a bus layout structure of the present invention.

FIG. 3b is a flow chart of a bus layout method for forming the bus layout structure of FIG. 3a.

FIG. 3c illustrates another bus layout structure of the present invention.

FIG. 3d is a flow chart illustrating a bus layout method for forming the bus layout structure of FIG. 3c

FIG. 3e illustrates how a laser beam is used to integrate the non-conductive film with the casing through the mask of FIG. 3c.

FIG. 3f illustrates another bus layout structure of the present invention.

FIG. 3g is a bus layout method for realizing the bus layout structure of FIG. 3f.

FIG. 4a illustrates a connection structure between battery cells and conducting buses of the present invention.

FIG. 4b illustrates another connection structure between battery cells and conducting buses of the present invention.

FIG. 4c illustrates another connection structure between battery cells and conducting buses of the present invention.

FIG. 4d is a flow chart of a connection method for realizing the connection structure of FIG. 4c.

FIG. 5a illustrates a connection structure between a circuit board and conducting buses of the present invention.

FIG. 5b illustrates another connection structure between a circuit board and conducting buses of the present invention.

FIG. 5c illustrates another connection structure between a circuit board and conducting buses of the present invention.

FIG. 5d shows the connection structure of FIG. 5c in part.

### DETAILED DESCRIPTION

### Battery Module

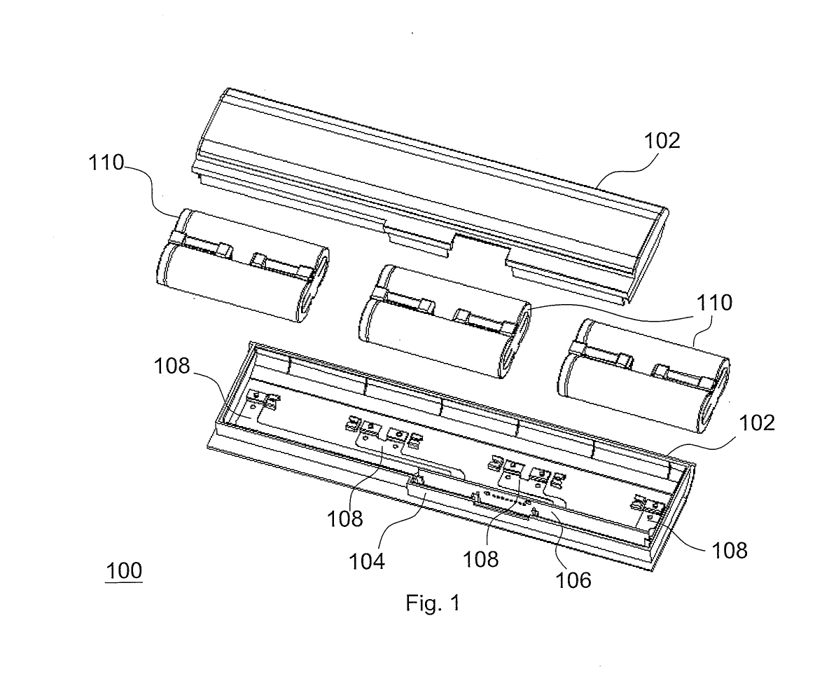

FIG. 1 illustrates a battery module embodiment of the present invention. As shown in FIG. 1, a battery module 100 comprises at least a casing 102 which is capable of supporting a plurality of battery cells and has a circuit board holding structure 104; a circuit board 106 held by the circuit board holding structure 104; a plurality of conducting buses 108 disposed on the casing 102 for electrically connecting the plurality of battery cells and the circuit board 106; and a plurality of battery cell sets 110, each of which comprising at least two battery cells, wherein any two of the plurality of battery cell sets 110 are independent to each other in structure to be affixed to or detached from the casing 102 respectively. Through the above-mentioned structure, the advantage of modular assembly is achieved.

Besides, for any two of the adjacent battery cell sets 110 of the battery module 100, the positive/negative electrode of a battery cell set 110 may share the same conducting bus 108 with the negative/positive electrode of another battery set 110 to thereby carry out the series connection of the two battery cell sets 110; or the positive/negative electrode of a battery cell set 110 may share the same conducting bus 108 with the positive/negative electrode of another battery set 110 to thereby realize the parallel connection of the two battery cell sets 110.

The present invention also provides a method to assemble the battery module 100, the method comprising the steps of assembling the battery cell sets 110, integrating the conducting buses 108 with the casing 102, combining the circuit board with the casing integrated with the conducting buses 108, and attaching the battery cell sets 110 to the casing 102. The detailed descriptions of the assembly of the battery cell set 110, the integration of the conducting buses 108 and the casing 102, the combination of the circuit board and the casing 102, and the arrangement of the battery cell sets 110 with the casing 102 are written below, respectively; therefore one of ordinary skill in the art will appreciate how to carry out the method in accordance with the disclosures of the specification.

### Battery Cell Set

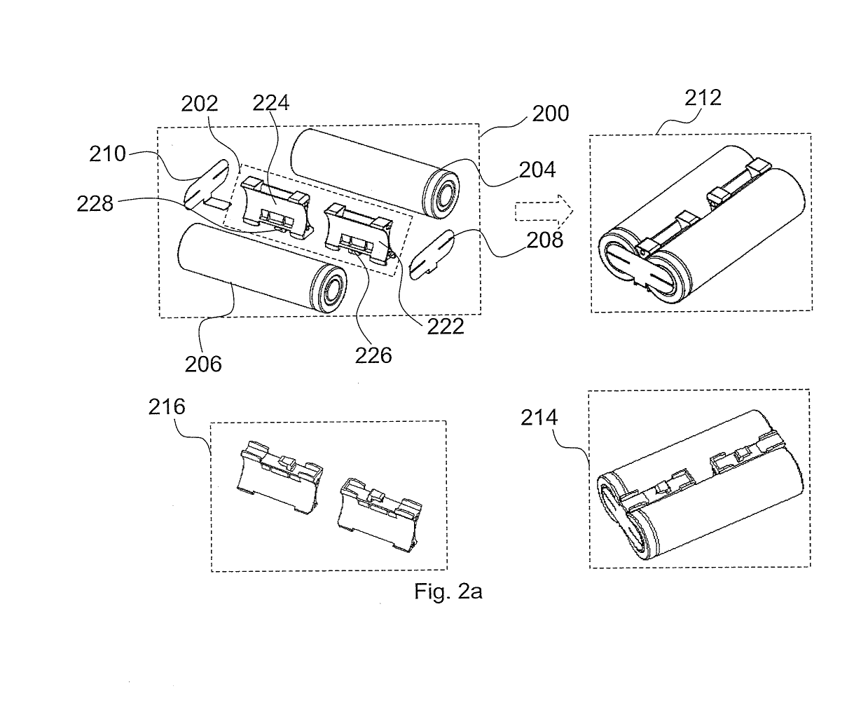

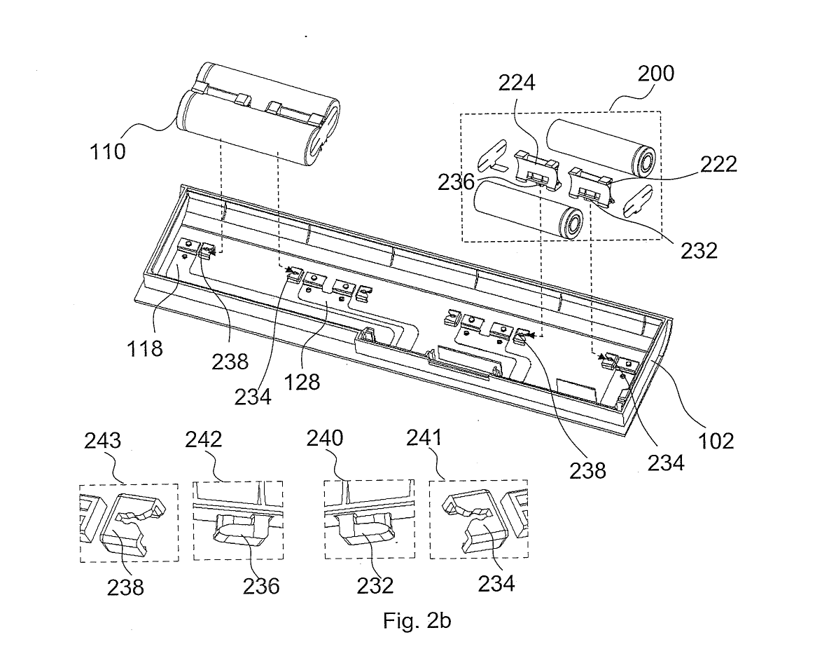

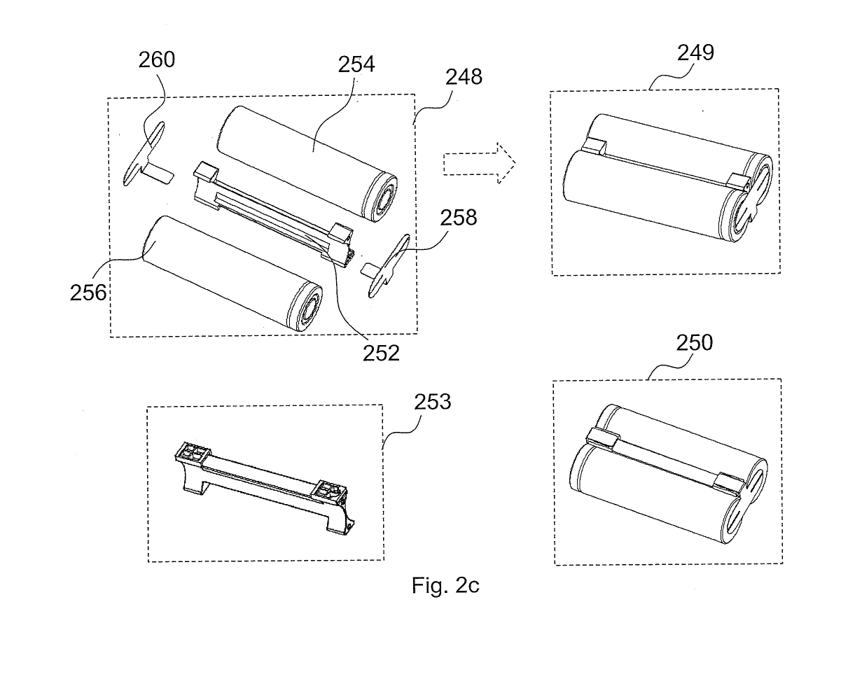

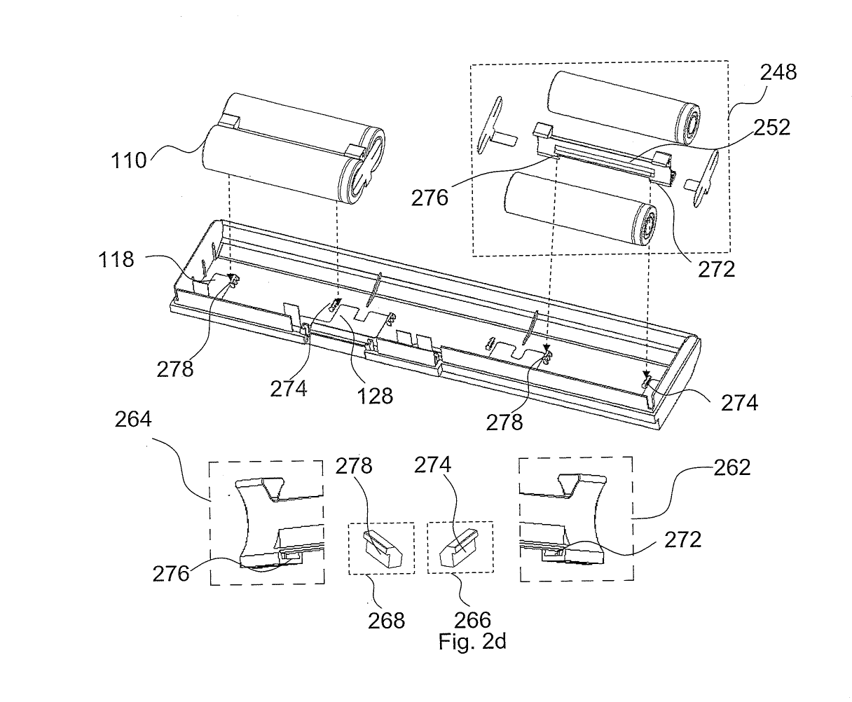

FIG. 2a illustrates a first embodiment of the battery cell set 110 of FIG. 1, comprising a battery cell set explosion diagram 200; a battery cell set top view 212; a battery cell set bottom view 214; and a moveable battery holder bottom view 216. As shown in FIG. 2a, a battery cell set 110 comprises a moveable battery holder 202 which includes a fastening structure at its bottom, the fastening structure capable of being affixed to the casing 102 and detached from the casing 102 in a reversible way; a first battery cell 204 disposed at a first side of the moveable battery holder 202, in which the contour of the first side matches the contour of the first battery cell (for example, if the first battery cell is cylindrical, the contour of the first side is in the shape of a half-circle), such that the utilization of the interior space of the battery module 100 can be optimized; a second battery cell 206 disposed at a second side of the moveable battery holder 202 to thereby embrace the moveable battery holder 202 with the first battery cell 204 from both of the first and second sides of the holder 202, in which the contour of the second side matches the contour of the second battery cell (for example, if the first battery cell is rectangular, the contour of the first side is in the shape of a half-rectangle) to save the interior space of the battery module 100 and the moveable battery holder 202 separates the first and second battery cells 204, 206 to avoid safety issues; a first conducting strip 208 for connecting the positive electrodes of the first and second battery cells 204, 206 to a first conducting bus 118 (as shown in FIG. 2b) among the plurality of conducting buses 108, in which the first conducting strip 208 has two electrode ends and one bus end, the two electrode ends are fixed to the positive electrodes of the first and second battery cells 204, 206, and the bus end is bent to the underside of the moveable battery holder 202 for connecting to the first conducting bus 118; and a second conducting strip 210 for connecting the negative electrodes of the first and second battery cells 204, 206 to a second conducting bus 128 (as shown in FIG. 2b) among the plurality of conducting buses 108, wherein the second conducting strip 210 also has two electrode ends and one bus end, the two electrode ends are fixed to the negative electrodes of the first and second battery cells 204, 206, and the bus end is bent to the underside of the moveable battery holder 202 for connecting to the second conducting bus 128.

Please note that since the first and second conducting strips 208, 210 are fixed to the positive and negative electrodes of the first and second battery cells 204, 206 while the first and second battery cells 204, 206 embrace the moveable battery holder 202, the first and second conducting strips 208, 210 thereby bind the cells 204, 206 and holder 202 together. In other words, the moveable battery holder 202, the first battery cell 204, the second battery cell 206, the first conducting strip 208 and the second conducting strip 210 are integrated to become the battery cell set 110. The way to fix the first and second conducting strips 208, 210 to the first and second battery cells 204, 206 can be realized through the known welding technique such as solder welding technique, laser spot welding technique, resistance welding technique, and ultrasonic welding technique. Please also note that after reading the present disclosure, a person of ordinary skill in the art will appreciate the amount of the moveable battery holder and the amount of the battery cell could be expanded by simply attaching an additional moveable battery holder to the exposed side of the first or second battery cell, attaching an additional battery cell to the additional moveable battery holder, and using larger conducting strips to carry out the connection of the battery cells and bind the cells and holders together in the way similar to the aforementioned description, that is to say each of the conducting strips having three electrode ends and one bus end for respectively connecting the battery cells and the conducting bus and for binding the battery cells and the moveable battery holders together.

Please refer to FIG. 2a, wherein the moveable battery holder 202 comprises a first moveable subsidiary holder 222 and a second moveable subsidiary holder 224. The first and second moveable subsidiary holders 222, 224 can be affixed to the casing 102 by the fastening structure of the moveable battery holder 202 and detached from the casing 102 in a reversible way. As shown in FIG. 2a, the direction from the first moveable subsidiary holder 222 to the second moveable subsidiary holder 224 defines an axis, the summed length of the first and second moveable subsidiary holders 222, 224 along the axis is shorter than the length of any of the first and second battery cells 204, 206 from its positive electrode to its negative electrode. Therefore, the first and second moveable subsidiary holders 222, 224 can move along the axis in opposite directions to thereby immobilize themselves on the casing 102 or separate themselves from the casing 102 in the reversible way. To be more specific, the battery cell set 110 can be affixed to the casing 102 or detached from the casing 102 in the reversible way through the operation of the first and second moveable subsidiary holders 222, 224.

The aforementioned first and second moveable subsidiary holders 222, 224 includes a first and a second subsidiary fastening structures 226, 228 respectively, so that they can be fixed to or detached from the casing 102 by the first and second subsidiary fastening structures 226, 228. Besides, said moving direction of the first and second moveable subsidiary holder 222, 224 is exemplary, not a limitation to the present invention. One of ordinary skill in the art will appreciate how to make the first and second moveable subsidiary holders 222, 224 move along the axis in the same direction to thereby immobilize themselves on the casing 102 or separate themselves from the casing 102 according to the disclosure of this specification.

FIG. 2b illustrates how the first and second subsidiary fastening structures 226 connect with the casing 102, comprising enlarged diagrams 240, 242 of the moveable battery holder 202 in part and enlarged diagrams 241, 243 of the casing 102 in part. As shown in FIG. 2b, the first subsidiary fastening structure 226 includes a first buckle 232 capable of clasping a first slot 234 of the casing 102 for affixing the first moveable subsidiary holder 222 to the casing 102 and separating from the first slot 234 for detaching the first moveable subsidiary holder 222 from the casing 102; and the second fastening structure 228 includes a second buckle 236 capable of clasping a second slot 238 of the casing 102 for attaching the second moveable subsidiary holder 224 to the casing 102 and separating from the first slot 234 for detaching the first moveable subsidiary holder 224 from the casing 102. More specifically, when the first and second moveable subsidiary holders 222, 224 are set on the casing 102, the first and second buckles 232, 236 stay between the first and second slots 234, 238; the first and second moveable subsidiary holders 222, 224 then move along the axis in the opposite directions respectively to have the first and second buckles 232, 235 clasp or separate from the first and second slots 234, 238 to carry out the engagement or detachment.

Please note that the aforementioned positions and numbers of the buckles and slots are not limitations to the present invention. A person having ordinary skill in the art can make appropriate changes to the embodiments in accordance with the disclosure of the specification. For instance, two slots may be set between two buckles so that the buckles can move toward each other to thereby clasp the slots respectively. For another instance, only one slot is set between two buckles and thus the buckles can move toward each other to thereby clasp the same slot. For further instance, slots could be formed on the bottom of the moveable battery holder while buckles could be formed on the casing. In fact, as long as the fastening(s) of the moveable battery holder 202 can match the fastening(s) of the casing 102 to bind the two together, such fastening(s) could be adopted by the present invention.

FIG. 2c illustrates a second embodiment of the battery cell set 110 of FIG. 1, comprising a battery cell set explosion diagram 248; a battery cell set top view 249; a battery cell set bottom view 250; and an immobile battery holder bottom view 253. As shown in FIG. 2c, a battery cell set 110 comprises an immobile battery holder 252 which includes a fastening structure at its bottom, the fastening structure capable of being affixed to the casing 102 and detached from the casing 102 in a reversible way; a first battery cell 254 disposed at a first side of the immobile battery holder 252, in which the contour of the first side matches the contour of the first battery cell 254 (for example, if the first battery cell 254 is cylindrical, the contour of the first side is in the shape of a half-circle), such that the utilization of the interior space of the battery module 100 can be optimized; a second battery cell 256 disposed at a second side of the immobile battery holder 252 to thereby embrace the immobile battery holder 252 with the first battery cell 254 from both of the first and second sides of the holder 252, in which the contour of the second side matches the contour of the second battery cell 256 (for example, if the second battery cell 256 is rectangular, the contour of the first side is in the shape of a half-rectangle) to thereby save the interior space of the battery module 100, and the immobile battery holder 252 separates the first and second battery cells 254, 256 to avoid safety issues; a first conducting strip 258 for connecting the positive electrodes of the first and second battery cells 254, 256 to a first conducting bus 118 (as shown in FIG. 2d) among the plurality of conducting buses 108, in which the first conducting strip 258 has two electrode ends and one bus end, the two electrode ends are fixed to the positive electrodes of the first and second battery cells 254, 256, and the bus end is bent to the underside of the immobile battery holder 252 for connecting to the first conducting bus 118; and a second conducting strip 210 for connecting the negative electrodes of the first and second battery cells 204, 206 to a second conducting bus 128 (as shown in FIG. 2d) among the plurality of conducting buses 108, wherein the second conducting strip 210 also has two electrode ends and one bus end, the two electrode ends are fixed to the negative electrodes of the first and second battery cells 254, 256, and the bus end is bent to the underside of the immobile battery holder 252 for connecting to the second conducting bus 128.

FIG. 2d illustrates how the fastening structure of the immobile battery holder 252 connects with the casing 102, comprising enlarged diagrams 262, 264 of the immobile battery holder 202 in part and enlarged diagrams 266, 268 of the casing 102 in part. As shown in FIG. 2b, the fastening structure of the immobile battery holder 252 includes a first slot 272 capable of engaging a first brim 274 of the casing 102; and a second slot 276 capable of engaging a second brim 278 of the casing 102, so that the immobile battery holder 252 can be fixed to the casing 102 by its fastening structure. In this embodiment, the two slots 272, 276 can be slightly pulled away to carry out the engagement between them and the two brims 274, 278, so as to fix the immobile battery holder 252 to the casing 102.

Please note that a person having ordinary skill in the art can make appropriate changes to the embodiments in accordance with the disclosure of the specification. For instance, the immobile battery holder 252 may have a plurality of pegs for being inserted into a plurality of holes of the casing 102. Basically, as long as the fastening(s) of the immobile battery holder 252 can match the fastening(s) of the casing 102 to bind the two together, such fastening(s) could be adopted by the present invention. Please also note that after reading the present disclosure, a person of ordinary skill in the art will appreciate the amount of the immobile battery holder and the amount of the battery cell could be expanded by simply attaching an additional immobile battery holder to the exposed side of the first or second battery cell, attaching an additional battery cell to the additional immobile battery holder, and using larger conducting strips to carry out the connection of the battery cells and bind the cells and holders together in the way similar to the aforementioned description, that is to say each of the conducting strips having three electrode ends and one bus end for respectively connecting the battery cells and the conducting bus and for binding the battery cells and the immobile battery holders together.

Please refer to FIGS. 2a and 2c again, wherein the conducting strips 208, 210, 258 and 260 can be fixed to the electrodes of the battery cells 204, 206, 254 and 256 by using solder free technique such as laser spot welding technique, resistance spot welding technique and ultrasonic welding technique, so as to achieve the eco-friendly purpose. Similarly, the connection between the conducting strips 208, 210, 258 and 260 and the conducting buses 108 can be realized by the above-mentioned welding technique.

### Bus Layout Structure and Method

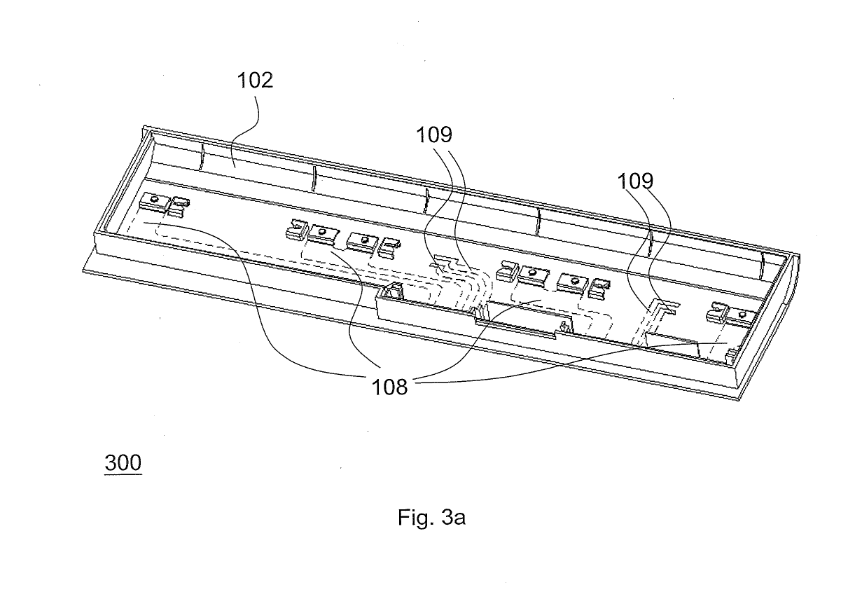

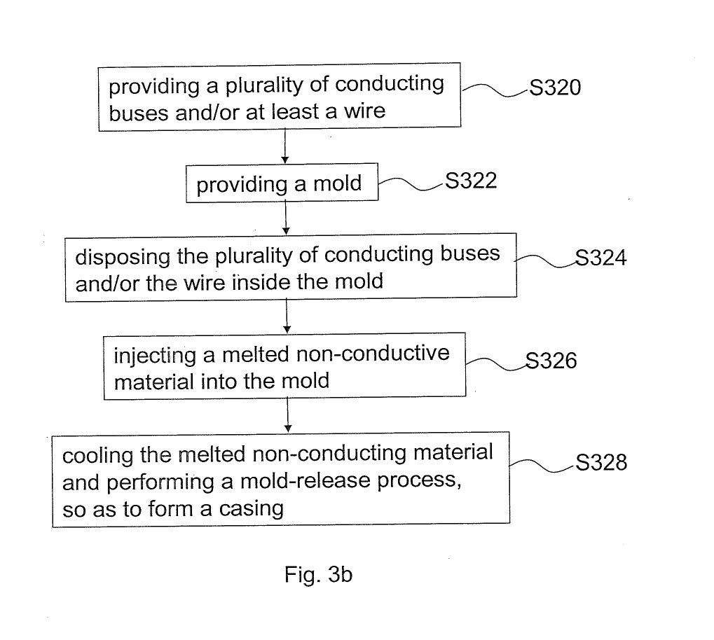

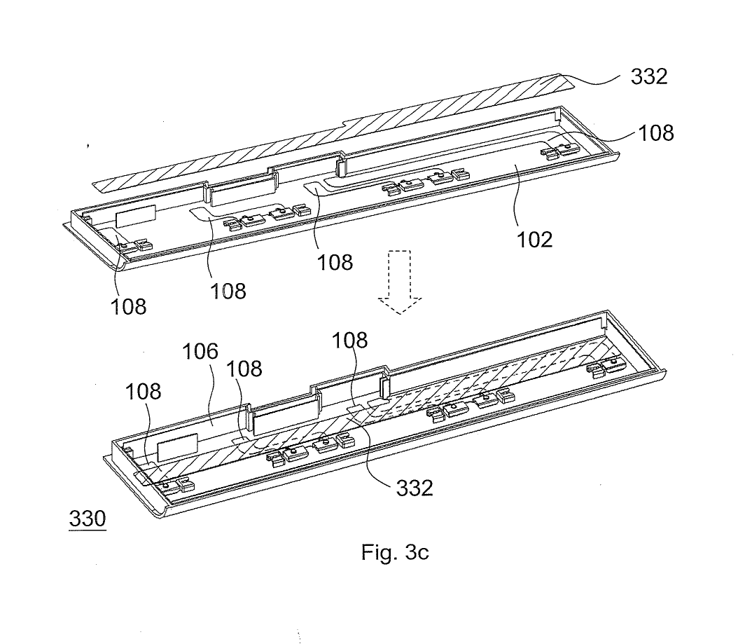

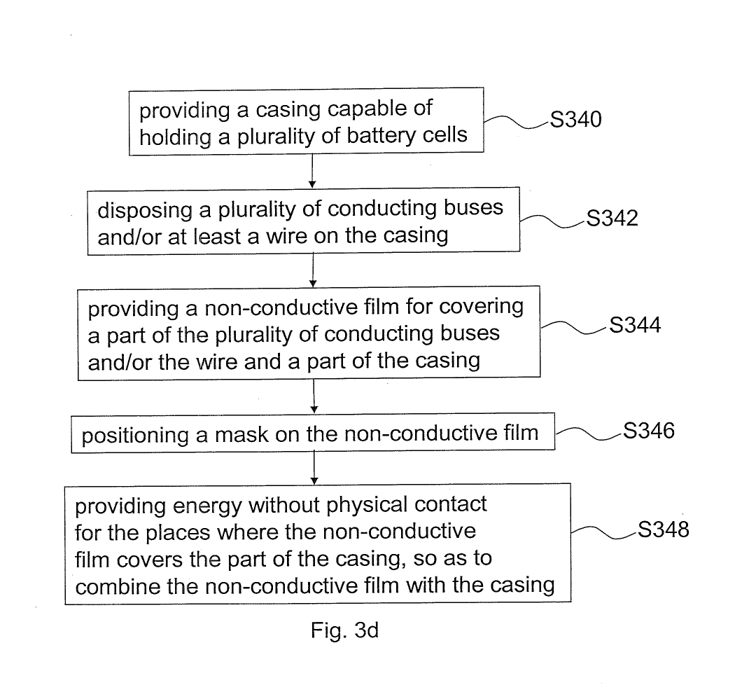

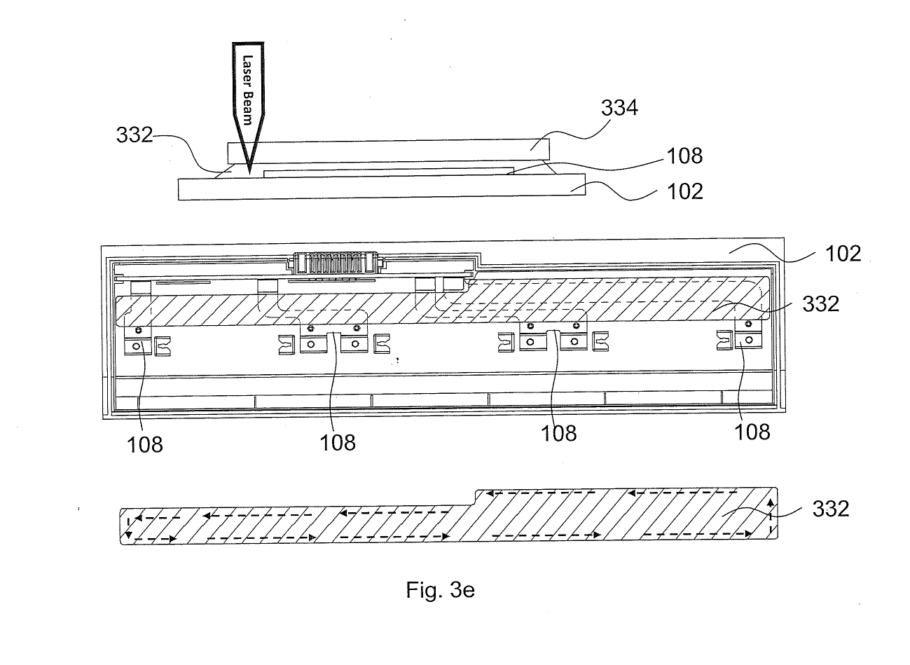

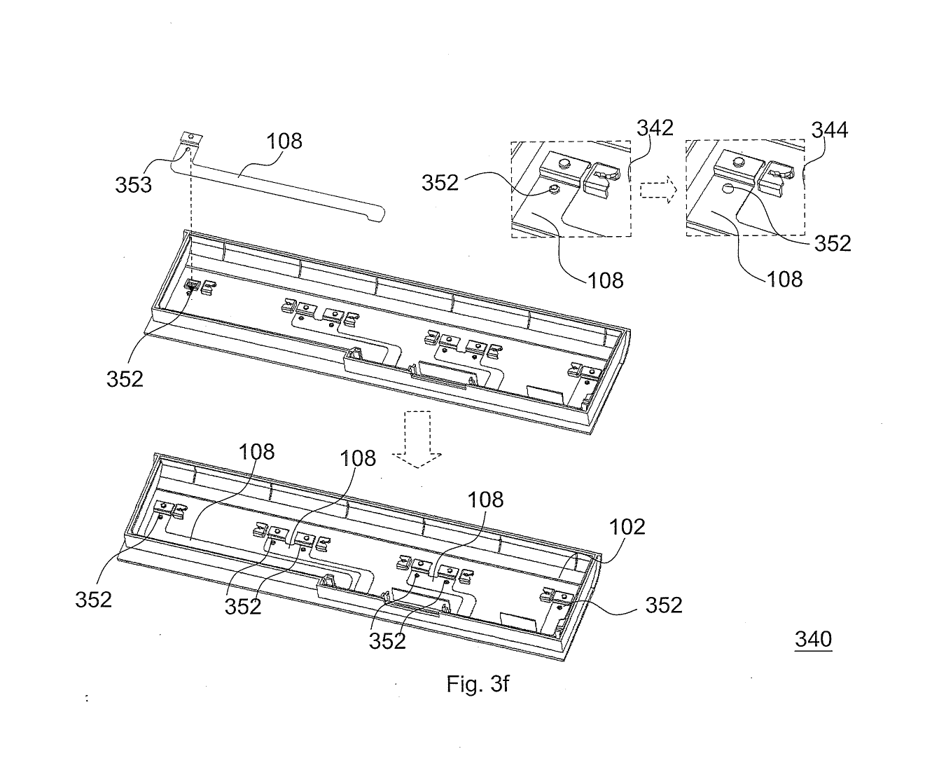

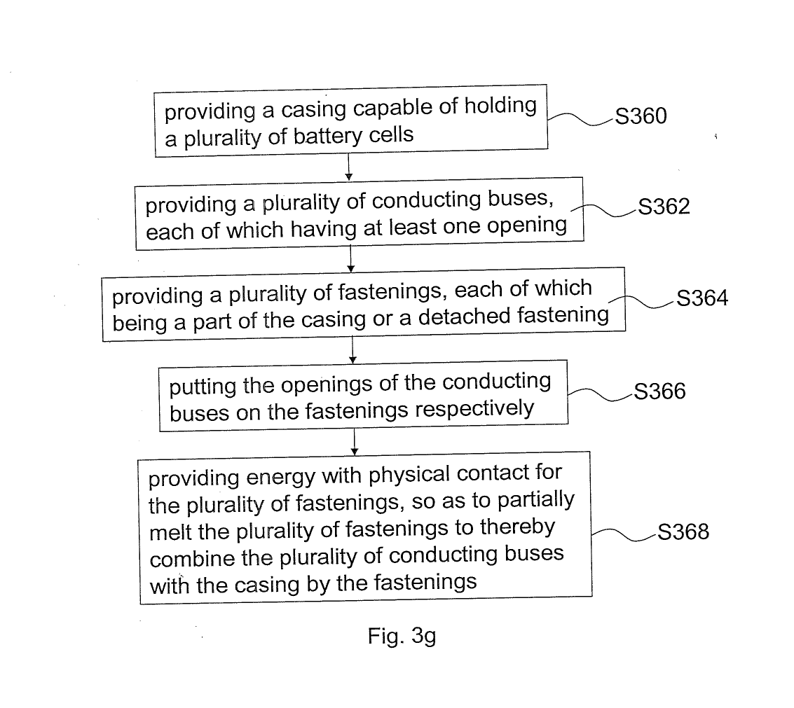

FIG. 3a illustrates a bus layout structure of the battery module 100 of the present invention, comprising an enlarged diagram 302 of the bus layout structure in part. As shown in FIG. 3a, a bus layout structure 300 comprises a casing 102 and a plurality of conducting buses 108 and/or at least a wire 109 (e.g. a wire for connecting a circuit board and a thermistor). The plurality of conducting buses 108 is implanted inside the casing 102, which defines an exposed part and an unexposed part. Each of the conducting buses 108 has one end for connecting a circuit board (e.g. the circuit board 106 of FIG. 1) and another end for connecting to the electrode of a battery cell set (e.g. the battery cell set 110 of FIG. 1). More specifically, the exposed part of the plurality of conducting buses 108 connects to the electrode of the battery cell set while the unexposed part is buried inside the casing 102 to avoid direct contact with the battery cell set because of safety concern.

FIG. 3b is a flow chart of a bus layout method for forming the bus layout structure 300 of FIG. 3a. As shown in FIG. 3b, the bus layout method comprises the following steps: step S320: providing a plurality of conducting buses and/or at least a wire; step S322: providing a mold; step S324: disposing the plurality of conducting buses and/or the wire inside the mold; step S326: injecting a melted non-conductive material (e.g. plastic material) into the mold; and step S328: cooling the melted non-conducting material and performing a mold-release process, so as to form a casing.

The casing mentioned above is capable of holding a plurality of battery cells and integrated with the plurality of conducting buses and/or the wire; a part of the plurality of conducting buses and/or the wire is exposed for connecting to the plurality of the battery cells; and another part of the plurality of conducting buses and/or the wire is implanted inside the casing to prevent exposure and thereby avoid direct contact with the plurality of the battery cells. Similarly, the wire has one end exposed for connecting to a temperature detector (e.g. a thermistor) and another end unexposed for connecting to a circuit board (e.g. the circuit board 106 of FIG. 1).

Please note that the aforementioned wire may be used for connecting to devices other than the temperature detector. This embodiment is characterized in combining the conducting buses and/or the wire with the casing; therefore, the device connected to the buses and/or the wire is not restricted and depends on design requirements.

FIG. 3c illustrates another bus layout structure for the battery module 100 of the present invention. As shown in FIG. 3c, a bus layout structure 330 comprises a casing 102, a plurality of conducting buses 108 and at least a non-conductive film 332 (e.g. a plastic film such as a Mylar film or a PET film). The plurality of conducting buses 108 is disposed on the casing 102 while the non-conductive film 332 covers a part of the plurality of the conducting buses 108 and a part of the casing 102, which thereby defines an exposed part and an unexposed part of the plurality of conducting buses 108. Each of the conducting buses has one end connected to a circuit board (e.g. the circuit board 106 of FIG. 1) and another end connected to the electrode of a battery cell set (e.g. the battery cell set 110 of FIG. 1). To be more specific, the exposed part of the conducting buses 108 is used for connecting the electrode of the battery cell set while the unexposed part of the connecting buses 108 is covered by the non-conductive film 332 to avoid direct contact with the battery cell set because of safety concern. Moreover, the non-conductive film 332 is welded with the casing 102 at the position where the non-conductive film 332 covers the casing 102, so that the non-conductive film 332 can fix the plurality of conducting buses 108 to the casing 102.

FIG. 3d is a flow chart illustrating a bus layout method for forming the bus layout structure 330 of FIG. 3c. As shown in FIG. 3d, the method comprises the following steps: step S340: providing a casing capable of holding a plurality of battery cells; step S342: disposing a plurality of conducting buses and/or at least a wire on the casing; step S344: providing a non-conductive film for covering a part of the plurality of conducting buses and/or the wire and a part of the casing; step S346: positioning a mask on the non-conductive film; and step S348: providing energy without physical contact for the places where the non-conductive film covers the part of the casing, so as to combine the non-conductive film with the casing in an irreversible way and thereby immobilize the plurality of conducting buses and/or the wire covered under the non-conductive film, wherein a part of the plurality of buses which is not covered by the non-conductive film is for connecting with the plurality of the battery cells.

The aforementioned step of providing energy without physical contact is realized through laser welding technique. FIG. 3e illustrates how a laser beam is used to integrate the non-conductive film 332 with the casing 102 through the mask 334. Referring to FIG. 3e, the mask 334 and the non-conductive film 332 are totally or partially transparent to the laser beam, so as to allow the laser beam passing them to carry out the fusion of the casing 102 and the non-conductive film 332. More specifically, the laser beam moves along the surrounding of the non-conductive film 332 to weld the film 332 and the casing 102 together. The mask 334 can exert pressure upon the non-conductive film 332 to thereby increase the fusion area and enhance the connection strength. More description on the fusion of a casing and a film can be found in the applicant's prior U.S. patent application (application Ser. No. 13/0921,48).

FIG. 3f illustrates another bus layout structure of the battery module 100 of the present invention, comprising two enlarged diagrams 342, 344 of the bus layout structure in part showing how a fastening fixes a bus to a casing. As shown in FIG. 3f, the bus layout structure 340 comprises a casing 102, a plurality of conducting buses 108 and a plurality of fastenings 352, wherein the plurality of fastenings 352 is an integrated part of the casing 102 or a plurality of detached fastenings independent of the casing 102. The plurality of conducting buses 108 is disposed on the casing 102 and has a plurality of openings 353; the plurality of fastenings 352 is positioned with the plurality of the openings 353; each of the fastenings 352 is inserted into one of the openings 353, so that one end of the fastening 352 stays under the opening and is fixed to the casing 102 while another end of the fastening 352 stays above the opening 353 and is fixed to the conducting bus 108 of the opening 353; and accordingly the plurality of conducting buses 108 is fixed to the casing 102 through the plurality of the fastenings 352.

In this embodiment, the plurality of fastenings 352 is a protrudent integrated part of the casing 102 and stands on the surface of the casing 102, so that the openings 353 of the conducting buses 108 can be put on the fastenings 352 to thereby position the conducting buses 108 on the casing 102. Afterward, the plurality of fastenings 352 is partially fused by a welding method such as a heat fusion welding method, an ultrasonic welding method or a vibration welding method, and then cooled to fix the conducting buses 108 and the casing 102 together. In another embodiment, the fastenings 352 are detached fastenings while the casing 102 has a plurality of holes for the insertion of the fastenings 352; therefore, the fastenings 352 can be inserted into the holes, the openings 353 of the conducting buses 108 can be put on the fastenings 352, and the fastenings 352 can be fused and then cooled to combine the casing 102 and the conducting buses 108 together.

FIG. 3g is a bus layout method for realizing the bus layout structure 340 of FIG. 3f. The method comprises the following steps: step S360: providing a casing capable of holding a plurality of battery cells; step S362: providing a plurality of conducting buses, each of which having at least one opening; step S364: providing a plurality of fastenings, each of which being a part of the casing or a detached fastening; step S366: putting the openings of the conducting buses on the fastenings respectively, wherein each of the fastenings is inserted into one of the openings, has one end staying under the opening and being fixed to the casing, and has another end staying above the opening and being fixed to the conducting bus of the opening; and step S368: providing energy with physical contact for the plurality of fastenings, so as to partially melt the plurality of fastenings to thereby combine the plurality of conducting buses with the casing by the fastenings, wherein the step of providing energy with physical contact utilizes one of the heat fusion welding technique, ultrasonic welding technique and vibration welding technique.

### Connection Structure Between Battery Cells and Conducting Buses

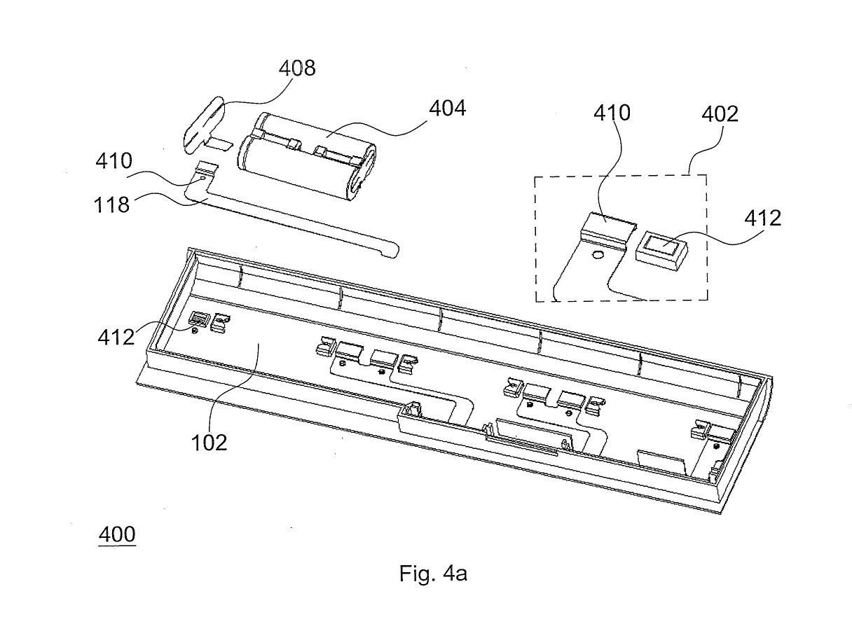

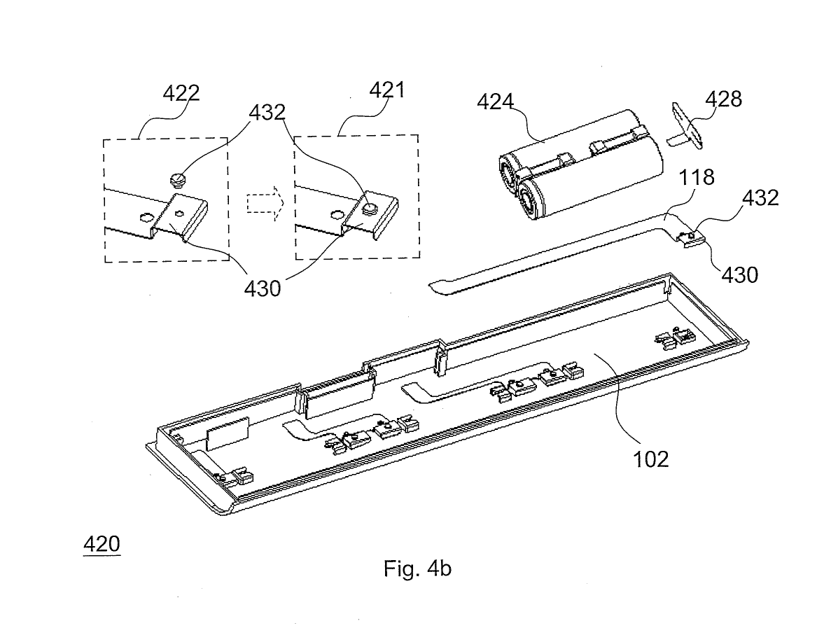

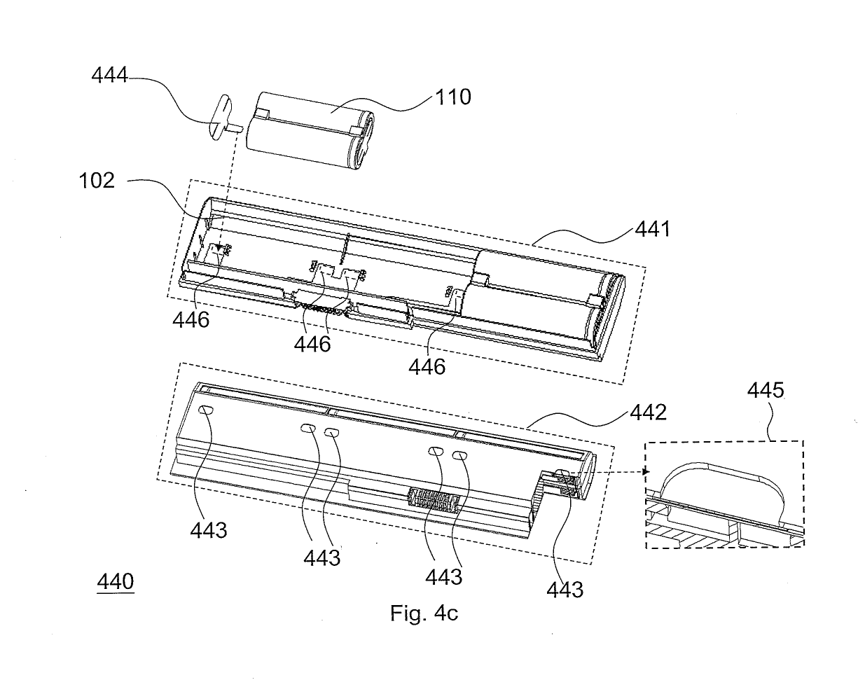

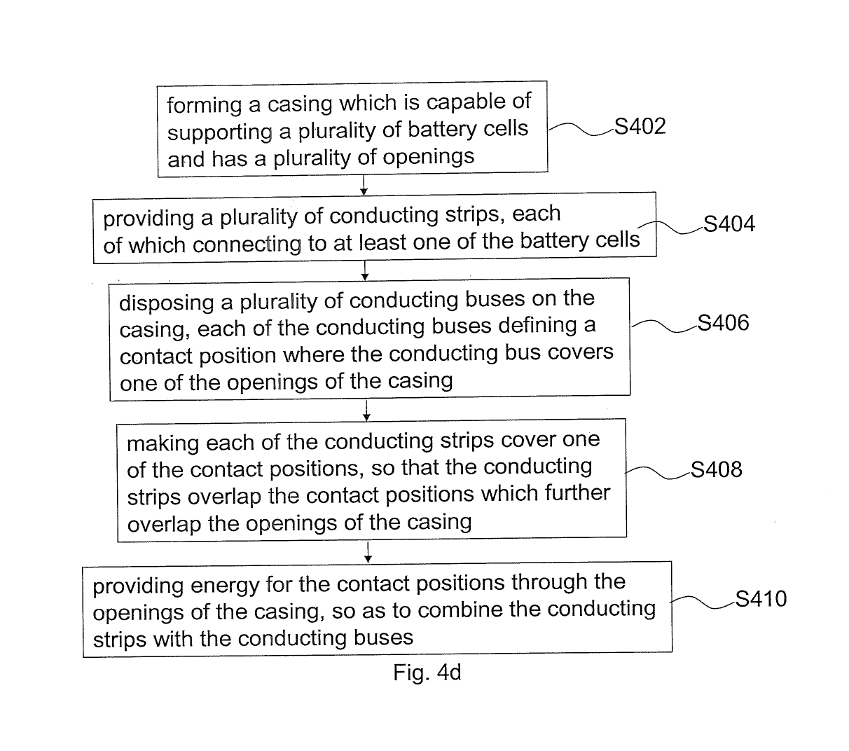

FIG. 4a illustrates a connection structure between battery cells and conducting buses of the battery module 100 of the present invention, including an enlarged diagram 402 showing a conducting bus and a flexible pad prior to their assembly. The connection structure 400 comprises: a casing 102 capable of holding a plurality of battery cells including a first battery cell 404; a plurality of conducting strips having a first conducting strip 408, each of the conducting strips having one end connecting to at least one of the battery cells; a plurality of conducting buses disposed on the casing 102 and connected to the plurality of battery cells through the plurality of conducting strips, wherein the plurality of conducting buses includes a first conducting bus 118, the first battery cell 404 connects to the first conducting bus 118 through the first conducting strip 408, and the first conducting bus 118 has a protrudent part 410 for realizing the contact between the first conducting bus 118 and the first conducting strip 408; and a flexible pad 412 (e.g. a plastic pad such as a rubber pad) placed under the protrudent part 410 on the casing 102 for providing an upward force to make the first conducting bus 118 closely connect to the first conducting strip 408.

In this embodiment, the aforementioned protrudent part 410 is in the shape of upside-down U; however, this is not a restriction to the present invention. As long as the protrudent part 410 is able to provide a zoom for accommodating the flexible pad 412 and able to closely contact the first conducting bus 118, the shape of the protrudent part 410 is unlimited. For example, the shape of trapezoid is adoptable.

FIG. 4b illustrates another connection structure between battery cells and conducting buses of the battery module 100 of the present invention, including enlarged diagrams 421, 422 showing how a conductive bump is set on a conducting bus. The connection structure 420 comprises: a casing 102 capable of supporting a plurality of battery cells including a first battery cell 424; a plurality of conducting strips including a first conducting strip 428, each of the conducting strips having one end connecting to at least one of the battery cells; a plurality of conducting buses disposed on the casing 102 and connected to the plurality of battery cells through the plurality of conducting strips, in which the plurality of conducting buses includes a first conducting bus 118, the first battery cell 424 connects to the first conducting bus 118 through the first conducting strip, and the first conducting bus 118 has a protrudent part 430 for realizing the contact between the first conducting bus 118 and the first conducting strip 428; and a conductive bump 432 placed on the protrudent part 430 for assisting the connection between the first conducting bus 118 and the first conducting strip 428. Please note that in this embodiment the conductivity of the conductive bump 432 (e.g. a silver bump) is higher than the conductivity of the first conducting bus (e.g. a copper bus) 118; however, this is not a restriction to the present invention. The first conducting bus 118 and the conductive bump 432 could be made of the same material.

Although the flexible pad 412 of FIG. 4a and the conductive bump 432 of FIG. 4b belong to different embodiments, they can be used in one embodiment to further ensure the conduction between the conducting strip and the conducting bus. More specifically, the flexible pad 412 of FIG. 4a may be disposed under the protrudent part 430 of FIG. 4b to provide an upward force for the first conducting bus 118; and the conductive bump 432 of FIG. 4b can be set on the protrudent part 410 of FIG. 4a to enhance the conduction between the first conducting bus 118 and the first conducting strip 408.

FIG. 4c illustrates another connection structure between battery cells and conducting buses of a battery module of the present invention, including a top view 441 of the battery module, a bottom view 442 of the battery module and a cross-section of the connection structure in part 445. As shown in FIG. 4c, the connection structure 440 comprises: a casing 102 capable of supporting a plurality of battery cell sets 110, the casing 102 having a plurality of openings 443; a plurality of conducting strips 444, each of which having one end connecting to at least one of the battery cell sets 110; and a plurality of conducting buses 108 disposed on the casing 102 for connecting with the plurality of battery cell sets 110 through the plurality of conducting strips 444, wherein each of the conducting buses 108 defines a contact position 446 where it covers one of the openings 443 of the casing 102, each of the conducting strips 444 covers one of the contact positions 446, and the conducting strips 444 are welded with the conducting buses 108 at the contact positions 446. In this embodiment, the fusion of the conducting strips 444 and the conducting buses 108 is carried out by providing energy for the contact positions via the openings 443, in which the way to provide energy utilizes laser spot welding technique, resistance spot welding technique, heat fusion welding technique or ultrasonic welding technique.

FIG. 4d is a flow chart of a connection method for realizing the connection structure 440 of FIG. 4c. The method comprises the following steps: step S402: forming a casing which is capable of supporting a plurality of battery cells and has a plurality of openings; step S404: providing a plurality of conducting strips, each of which connecting to at least one of the battery cells; step S406: disposing a plurality of conducting buses on the casing, the plurality of conducting buses connecting to the plurality of battery cells through the plurality of conducting strips, each of the conducting buses defining a contact position where the conducting bus covers one of the openings of the casing; step S408: making each of the conducting strips cover one of the contact positions, so that the conducting strips overlap the contact positions which further overlap the openings of the casing; and step S410: providing energy for the contact positions through the openings of the casing, so as to combine the conducting strips with the conducting buses and thereby carry out the electric connection between the conducting buses and the battery cells through the conducting strips.

### Connection Structure Between a Circuit Board and Conducting Buses

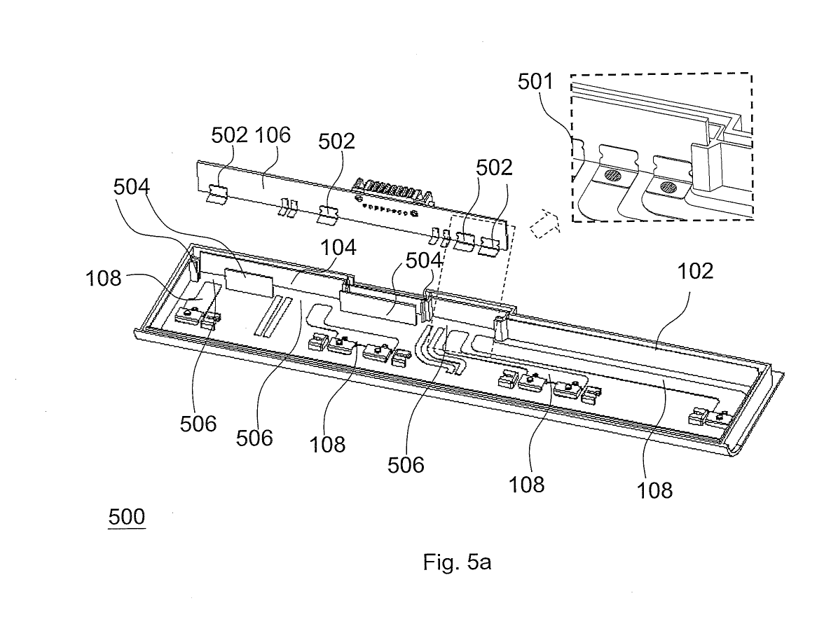

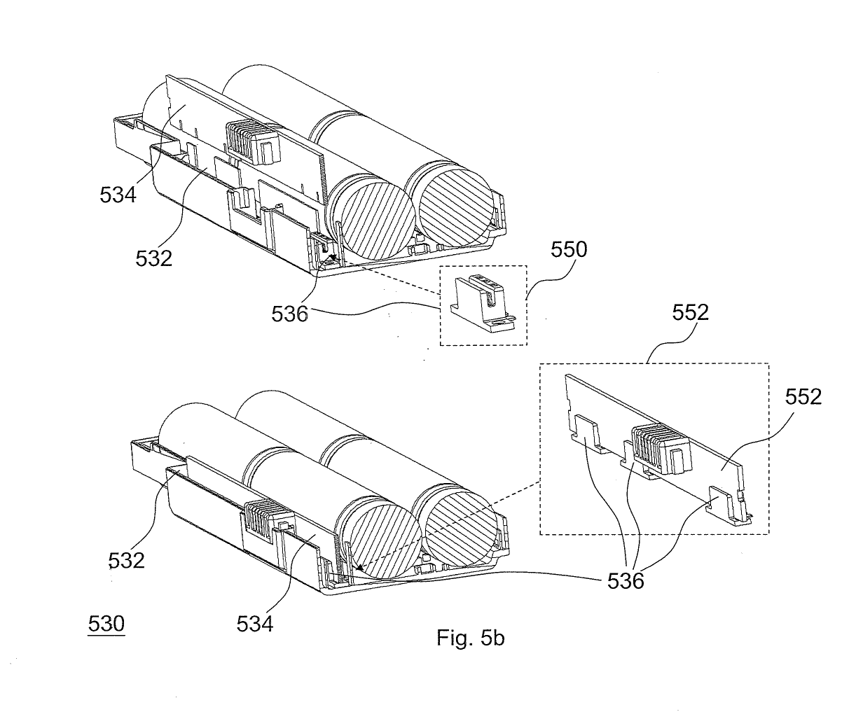

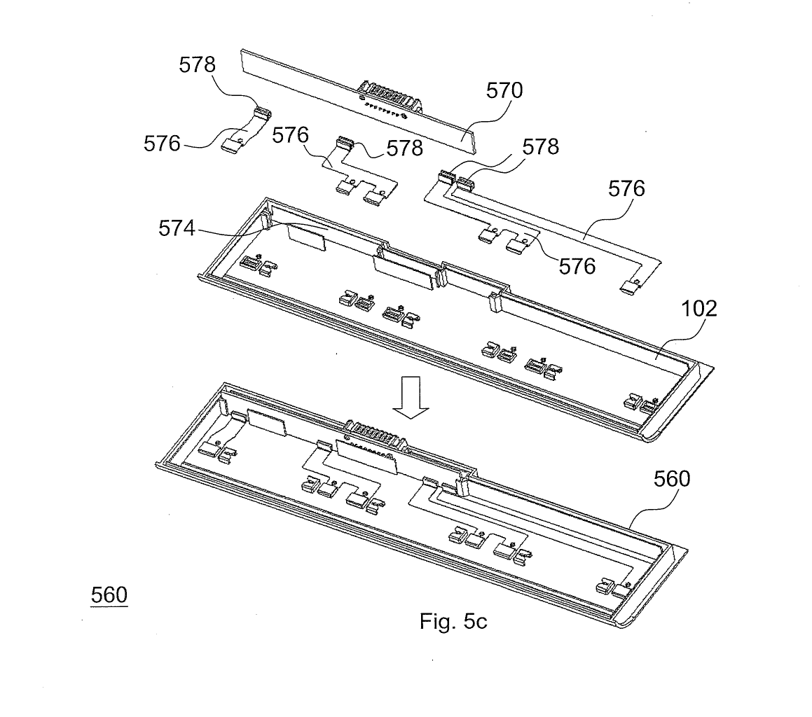

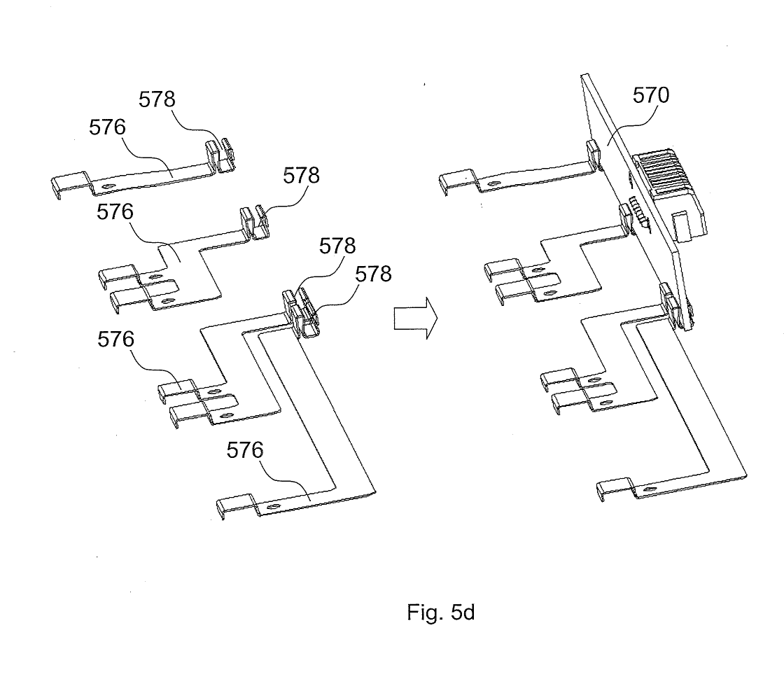

FIG. 5a illustrates a connection structure between a circuit board and conducting buses of the battery module 100 of the present invention, including an enlarged diagram 501 of the connection structure in part. The connection structure 500 comprises: a circuit board 106 including a plurality of contact positions (not shown) and a plurality of conductors 502, each of the conductors 502 having a vertical part for connecting one of the plurality of contact positions and having a cross-section in L-shape; a casing 102 being capable of supporting a plurality of battery cells and having a circuit board holding structure 104, the circuit board holding structure 104 including at least a holding space for accommodating the circuit board 106, a plurality of supports 504 for sustaining the circuit board 106 from both sides of the circuit board 106, and at least one connection gate 506; and a plurality of conducting buses 108 disposed on the casing 102, wherein each of the plurality of conductors 502 has a horizontal part paralleling the casing 102, and the horizontal parts of the plurality of conductors 502 connect with the plurality of conducting buses 108, so that the connection between the circuit board 102 and the conducting buses 108 is carried out by the conductors 502 via the connection gate 506.

Please note that the conductor 502 can be welded to the plurality of contact positions of the circuit board 106 and/or the conducting buses 108 through solder-free welding technique such as laser spot welding technique, resistance welding technique, and ultrasonic welding technique. Therefore, the connection between the conductors 502 and the contact positions and/or the conducting buses 108 will possess no solder, and thus achieve the eco-friendly purpose.

FIG. 5b illustrates another connection structure between a circuit board and conducting buses of the battery module 100 of the present invention, including an enlarged diagram 550 of a connector and another enlarged diagram 552 showing the combination of a circuit board and the connector. As shown in FIG. 5b, the connection structure 530 comprises a circuit board holding structure 532 for accommodating a circuit board 534; and a plurality of connectors 536 disposed in the circuit board holding structure 532 for holding the circuit board 534 and connecting to a plurality of conducting buses of a casing. Each of the connectors 536 includes an elastic sheet with one end connecting and pressing the circuit board 534 and another end electrically connecting to the plurality of conducting buses, which thereby connects the circuit board 534 and the plurality of conducting buses. The applicant also discloses relative description on this embodiment in the previously filed U.S. patent application (application Ser. No. 13/079,535).

FIG. 5c illustrates another connection structure between a circuit board and conducting buses of the battery module 100 of the present invention. The connection structure 560 comprises a circuit board 570 including a plurality of contact positions (not shown); a casing 102, capable of supporting a plurality of battery cells, having a circuit board holding space 574 for accommodating the circuit board 570; and a plurality of conducting buses 576 disposed on the casing 102, each of the conducting buses 576 having one end connecting to one of the plurality of battery cells and another end as a circuit board holding part 578 positioned at the circuit board holding space 574 for holding the circuit board 570. The circuit board holding part 578 has a cross-section in the shape of U or the like suitable for holding and immobilizing the circuit board 570; meanwhile, the circuit board holding part 578 also electrically connects to the contact positions of the circuit board 570 to thereby electrically connect the plurality of battery cells and the circuit board 570. Comparing to the embodiment of FIG. 5b, this embodiment eliminates using the connectors 536 of FIG. 5b by forming the circuit board holding parts 578 of the conducting buses 576; as a result, the cost of connectors 536 is saved.

FIG. 5d shows the connection structure 560 in part. It is clearly shown in FIG. 5d that the cross-sections of the circuit board holding parts 578 are in the shape of U. The U shape has a narrow opening and a wider bottom, which is suitable for holding and immobilizing the circuit board 570. More specifically, the circuit board 570 is pushed and pressed from its both sides by the narrow opening of the U shape. However, this is not a restriction to the present invention. Other immobilization methods such as using fastenings of the circuit board 570 with corresponding fastenings of the circuit board holding parts 578 or filling the circuit board holding parts 578 with conductive adhesive could be adopted by the present invention.

Moreover, the U shape is in a broad sense. Its outline, contour and/or curve could be changed in accordance with the practical design requirement. In fact, even other shapes such as a reversed Ω shape and a triangle shape could be options for the present invention as long as the shape can hold and immobilize the circuit board 570 well.

Finally, please note that the casing of each of the aforementioned embodiments could be an upper casing or a bottom casing of a battery module; the terms of top, bottom, length, width and the like are used for description, not as restriction to the implementation of the present invention. Actually, in another way of description, other terms could be used for interpreting the same meaning Furthermore, any of the aforementioned embodiments can be combined with one or more of the other embodiments as long as there is no conflict, so as to realize the different aspects of the present invention.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A battery module, comprising:
a casing, capable of supporting a plurality of battery cells, including a circuit board holding structure;
a circuit board held by the circuit board holding structure;
a plurality of conducting buses disposed on the casing for electrically connecting the plurality of battery cells and the circuit board; and
a plurality of battery cell sets, any two of which being independent of each other in structure and capable of being affixed to and detached from the casing respectively, each of the plurality of battery cell sets comprising:
a battery holder including a fastening structure capable of being affixed to the casing;
a first battery cell disposed at a first side of the battery holder;
a second battery cell disposed at a second side of the battery holder, so that the first battery cell and the second battery cell embrace the battery holder from the first and second sides of the battery holder;
a first conducting strip for electrically connecting positive electrodes of the first and second battery cells to a first conducting bus of the plurality of conducting buses; and
a second conducting strip for electrically connecting negative electrodes of the first and second battery cells to a second conducting bus of the plurality of conducting buses,
wherein any two of the battery cell sets neighboring on each other share the same first or second conducting bus.

2. The battery module of claim 1, wherein the battery holder further comprises:
a first movable subsidiary holder; and
a second movable subsidiary holder independent of the first moveable subsidiary holder,
wherein the first and second subsidiary holders are affixed to the casing capable of being detached from the casing in a reversible way.

3. The battery module of claim 1, wherein each of the first and second conducting strip includes two electrode-connection ends and one bus-connection end, the two electrode-connection ends being affixed to the electrodes of the first or second battery cell and the bus-connection end being bent to an underside of the battery holder for connecting to the first or second conducting bus.

4. The battery module of claim 1, wherein each of the plurality of conducting buses has one end electrically connected to the circuit board; a part of the plurality of conducting buses is exposed to connecting to the plurality of battery cell sets; and another part of the plurality of conducting buses is implanted inside the casing without exposing itself, so as to avoid direct contact with the plurality of battery cell sets.

5. The battery module of claim 1, wherein the electrodes of the first and second battery cells electrically connect with the first conducting bus through the first conducting strip; a protrudent part of the first conducting bus physically connects to the first conducting strip; and a flexible pad is disposed under the protrudent part on the casing to provide the protrudent part with an upward force for making the protrudent part closely contact the first conducting strip.

6. The battery module of claim 1, wherein the electrodes of the first and second battery cells electrically connect with the first conducting bus through the first conducting strip; the first conducting bus has a protrudent part for connecting to the first conducting strip; and a conductive bump is disposed on the protrudent part for promoting close contact with the first conducting strip.

7. The battery module of claim 1, wherein the circuit board holding structure comprises:
a holding space for accommodating the circuit board and the components thereof;
a plurality of supports for sustaining the circuit board from both sides of the circuit board; and
at least a connection gate for the connection between the circuit board and the plurality of the conducting buses.

8. The battery module of claim 7, wherein the circuit board has a plurality of conductors for connecting the circuit board and the plurality of the conducting buses through the connection gate; and the cross-section of each of the conductors is in the shape of L.

9. A battery cell assembly structure, comprising:
a moveable battery holder including a fastening structure capable of being affixed to a casing and detached from the casing in a reversible way;
a first battery cell disposed at a first side of the moveable battery holder;
a second battery cell disposed at a second side of the moveable battery holder, so that the first battery cell and the second battery cell embrace the moveable battery holder from both of the first and second sides;
a first conducting strip being electrically connected to positive electrodes of the first and second battery cells; and
a second conducting strip being electrically connected to negative electrodes of the first and second battery cells.

10. The battery cell assembly structure of claim 9, wherein the moveable battery holder comprises:
a first movable subsidiary holder including a first fastening structure capable of being affixed to the casing and detached from the casing in the reversible way; and
a second movable subsidiary holder including a second fastening structure capable of being affixed to the casing and detached from the casing in the reversible way,
wherein an axis is defined along the direction from the first moveable subsidiary holder to the second moveable subsidiary holder; the summed length of the first and second moveable subsidiary holders along the axis is shorter than the length of the first or second battery cell from its positive electrode to its negative electrode; and the first and second moveable subsidiary holder can move along the axis to thereby immobilize themselves on the casing or separate themselves from the casing in the reversible way.

11. The battery cell assembly structure of claim 10, wherein the first and second moveable subsidiary holders move in opposite directions along the axis to thereby be affixed to the casing or detached from the casing in the reversible way.

12. The battery cell assembly structure of claim 11, wherein the first fastening structure includes a first buckle capable of clasping a first slot of the casing; and the second fastening structure includes a second buckle capable of clasping a second slot of the casing.

13. The battery cell assembly structure of claim 9, wherein the fastening structure includes at least one buckle capable of clasping a slot of the casing.

14. The battery cell assembly structure of claim 9, wherein each of the first and second conducting strips has two electrode connection ends and one bus end; the two electrode ends are connected to the electrodes of the first and second battery cells; and the bus end is bent to an underside of the moveable battery holder to be ready for connecting to a conducting bus on the casing.

15. The battery cell assembly structure of claim 14, wherein the connection between the two electrode ends and the electrodes of the first and second battery cells carries no solder; and the connection between the bus end and the conducting bus carries no solder.

16. The battery cell assembly structure of claim 9, wherein the connection between the first conducting strip and the positive electrodes of the first and second battery cells possesses no solder; and the connection between the second conducting strip and the negative electrodes of the first and second battery cells possesses no solder.

17. A battery cell assembly structure, comprising:
an immobile battery holder including a fastening structure capable of being fixed to a casing;
a first battery cell disposed at a first side of the immobile battery holder;
a second battery cell disposed at a second side of the immobile battery holder, so that the first battery cell and the second battery cell embrace the immobile battery holder from both of the first and second sides;
a first conducting strip being electrically connected to positive electrodes of the first and second battery cells; and
a second conducting strip being electrically connected to negative electrodes of the first and second battery cells,
wherein each of the first and second conducting strips has two electrode connection ends and one bus end; the two electrode ends are connected to the electrodes of the first and second battery cells; and the bus end is bent to an underside of the immobile battery holder to be ready for connecting to a conducting bus on the casing.

18. The battery cell assembly structure of claim 17, wherein the connection between the first conducting strip and the positive electrodes of the first and second battery cells possesses no solder.

19. A bus layout structure of a battery module, comprising:
a casing for holding a plurality of battery cells; and
a plurality of conducting buses being integrated with the casing,
wherein one end of each of the plurality of conducting buses is for electrically connecting to a circuit board; a part of the plurality of conducting buses is exposed for connecting with the plurality of battery cells; and another part of the plurality of conducting buses is implanted inside the casing without exposing itself, so as to avoid direct contact with the plurality of battery cells.

20. The bus layout structure of the battery module of claim 19, further comprising:
at least a wire integrated with the casing,
wherein one end of the wire is for connecting to the circuit board; another end of the wire is exposed for connecting with a temperature detector; an unexposed part of the wire is implanted inside the casing; and the temperature detector is for detecting the temperature of at least one of the plurality of the battery cells.

21. A bus layout method for a battery module, comprising:
providing a plurality of conducting buses and/or at least a wire;
providing a mold;
disposing the plurality of conducting buses and/or the wire inside the mold;
injecting a melted non-conductive material into the mold; and
cooling the melted non-conducting material and performing a mold-release process, so as to form a casing,
wherein the casing is capable of holding a plurality of battery cells and integrated with the plurality of conducting buses and/or the wire; a part of the plurality of conducting buses and/or the wire is exposed for connecting to the plurality of the battery cells; and another part of the plurality of conducting buses and/or the wire is implanted inside the casing to avoid direct contact with the plurality of the battery cells.

22. The bus layout method for the battery module of claim 21, wherein one end of the wire is for connecting to a circuit board; another end of the wire is for connecting to a temperature detector;
an unexposed part of the wire is implanted inside the casing; and the temperature detector is for detecting the temperature of at least one of the plurality of battery cells.

23. A bus layout structure of a battery module, comprising:
a casing capable of holding a plurality of battery cells;
a plurality of conducting buses disposed on the casing, wherein a part of the plurality of conducting buses is exposed and another part of the plurality of conducting buses is unexposed; and
a non-conductive film covering the unexposed part of the plurality of conducting buses and being fixed to the casing, so as to immobilize the plurality of conducting buses;
wherein the exposed part of the plurality of conducting buses is for connecting to the plurality of battery cells.

24. A bus layout method for a battery module, comprising:
providing a casing capable of holding a plurality of battery cells;
disposing a plurality of conducting buses and/or at least a wire on the casing;
providing a non-conductive film for covering a part of the plurality of conducting buses and/or the wire and a part of the casing;
positioning a mask on the non-conductive film; and
providing energy without physical contact for the places where the non-conductive film covers the part of the casing, so as to combine the non-conductive film with the casing in an irreversible way and thereby immobilize the plurality of conducting buses and/or the wire covered by the non-conductive film,
wherein a part of the plurality of buses which is not covered by the non-conductive film is for connecting with the plurality of the battery cells.

25. The bus layout method for the battery module of claim 24, wherein the uncovered part of the wire connects to a temperature detector which is used for detecting the temperature of at least one of the battery cells.

26. The bus layout method for the battery module of claim 24, wherein the step of providing energy without physical contact utilizes a laser welding technique; and the mask has a transparent part for allowing a laser beam to pass to combine the non-conductive film with the casing.

27. A bus layout structure of a battery module, comprising:
a casing capable of holding a plurality of battery cells;
a plurality of conducting buses, each of which having at least one opening; and
a plurality of fastenings, each of which being a part of the casing or a detached fastening,
wherein each of the plurality of fastenings is inserted into one of the openings, has one end staying under the opening and being fixed to the casing, and has another end staying above the opening and being fixed to the conducting bus of the opening.

28. A bus layout method for a battery module, comprising:
providing a casing capable of holding a plurality of battery cells;
providing a plurality of conducting buses, each of which having at least one opening;
providing a plurality of fastenings, each of which being a part of the casing or a detached fastening;
putting the openings of the conducting buses on the plurality of fastenings respectively, wherein each of the plurality of fastenings is inserted into one of the openings and has one end fixed to the casing and another end fixed to the conducting bus of the opening; and
providing energy with physical contact for the plurality of fastenings, so as to partially melt the plurality of fastenings to thereby combine the plurality of conducting buses with the casing by the fastenings,
wherein the step of providing energy with physical contact utilizes one of the heat fusion welding technique, ultrasonic welding technique and vibration welding technique.

29. A connection structure between battery cells and conducting buses of a battery module, comprising:
a casing capable of holding a plurality of battery cells including a first battery cell;
a plurality of conducting strips having a first conducting strip, each of the conducting strips having one end connecting to at least one of the battery cells;
a plurality of conducting buses disposed on the casing and connected to the plurality of battery cells through the plurality of conducting strips, wherein the plurality of conducting buses includes a first conducting bus, the first battery cell connects to the first conducting bus through the first conducting strip, and the first conducting bus has a protrudent part for realizing the contact between the first conducting bus and the first conducting strip; and
a flexible pad placed under the protrudent part on the casing for providing an upward force to make the first conducting bus closely connect to the first conducting strip.

30. The connection structure between battery cells and conducting buses of the battery module of claim 29, further comprising:
a conductive bump disposed on the protrudent part of the first conducting bus for assisting the connection between the first conducting bus and the first conducting strip.

31. The connection structure between battery cells and conducting buses of the battery module of claim 30, wherein the conductivity of the conductive bump is higher than the conductivity of the first conducting bus.

32. A connection structure of battery cells and conducting buses of a battery module, comprising:
a casing capable of supporting a plurality of battery cells including a first battery cell;
a plurality of conducting strips including a first conducting strip, each of the conducting strips having one end connecting to at least one of the battery cells;
a plurality of conducting buses disposed on the casing and connected to the plurality of battery cells through the plurality of conducting strips, wherein the plurality of conducting buses includes a first conducting bus, the first battery cell connects to the first conducting bus through the first conducting strip, and the first conducting bus has a protrudent part for realizing the contact between the first conducting bus and the first conducting strip; and
a conductive bump placed on the protrudent part for assisting the connection between the first conducting bus and the first conducting strip.

33. The connection structure between battery cells and conducting buses of the battery module of claim 32, wherein the conductivity of the conductive bump is higher than the conductivity of the first conducting bus.

34. The connection structure between battery cells and conducting buses of the battery module of claim 32, wherein the conductive bump is made of gold or silver and the first conducting bus is made of copper.

35. A connection structure between battery cells and conducting buses of a battery module, comprising:
a casing capable of supporting a plurality of battery cells, the casing having a plurality of openings;
a plurality of conducting strips, each of which having one end connecting to at least one of the battery cells; and
a plurality of conducting buses disposed on the casing for connecting with the plurality of battery cells through the plurality of conducting strips, wherein each of the conducting buses defines a contact position where it covers one of the openings of the casing, each of the conducting strips covers one of the contact positions, and the conducting strips are welded with the conducting buses at the contact positions.

36. A connection method for connecting battery cells and conducting buses of a battery module, comprising:
forming a casing which is capable of supporting a plurality of battery cells and has a plurality of openings;
providing a plurality of conducting strips, each of which connecting to at least one of the battery cells;
disposing a plurality of conducting buses on the casing, the plurality of conducting buses connecting to the plurality of battery cells through the plurality of conducting strips, each of the conducting buses defining a contact position where it covers one of the openings of the casing;
making each of the conducting strips cover one of the contact positions, so that the conducting strips overlap the contact positions which further overlap the openings of the casing; and
providing energy for the contact positions through the openings of the casing, so as to combine the conducting strips with the conducting buses and thereby carry out the electric connection between the conducting buses and the battery cells through the conducting strips.

37. The connection method for connecting battery cells and conducting buses of the battery module of claim 36, wherein the step of providing energy for the contact positions utilizes one of a laser welding technique, spot welding technique, heat fusion welding technique and ultrasonic welding technique.

38. A connection structure between a circuit board and conducting buses of a battery module, comprising:
a circuit board including:
a plurality of contact positions; and
a plurality of conductors, each of which having a vertical part for connecting one of the plurality of contact positions and having a cross-section in L-shape;
a casing being capable of supporting a plurality of battery cells and having a circuit board holding structure which comprises:
at least a holding space for accommodating the circuit board;
a plurality of supports for sustaining the circuit board from both sides of the circuit board; and
at least a connection gate; and
a plurality of conducting buses disposed on the casing,
wherein each of the plurality of conductors has a horizontal part paralleling the casing, and the horizontal parts of the plurality of conductors connect with the plurality of conducting buses, so that the connection between the circuit board and the conducting buses is carried out by the conductors via the connection gate.

39. The connection structure between the circuit board and conducting buses of the battery module of claim 38, wherein the connection between the conductors and the conducting buses possess no solder.

40. A connection structure between a circuit board and conducting buses of a battery module, comprising:
a circuit board,
a casing capable of supporting a plurality of battery cells; and
a plurality of conducting buses disposed on the casing, wherein each of the conducting buses has one end connecting to one of the battery cells and another end as a board connection part, each of the board connection parts has a cross-section in U-shape, upside-down Ω-shape, or triangle-bell shape and is capable of holding the circuit board, and the circuit board can thereby electrically connect to the plurality of battery cells through the board connection parts of the conducting buses.

41. A battery module assembly method, comprising:
assembling a plurality of battery cell sets, each of which including a plurality of battery cells and at least one battery holder;
integrating a plurality of conducting buses with a casing, in which a part of the conducting buses is exposed to electrically connect the battery cell sets while another part of the conducting buses is unexposed to prevent itself from connecting the battery cell sets;
combining a circuit board with the casing; and
attaching the plurality of battery cell sets to the casing separately.
